(19) United States
(12) Patent Application Publication
(10) Pub. No.: US 2026/0364643 A1
(43) Pub. Date: Nov. 19, 2026

(54) COOKING GRILL CLEANING TOOLS WITH MULTIPLE CONFIGURATIONS, AND RELATED METHODS OF USE

(71) Applicant: Lorraine Campbell, County of Grande Prairie (CA)

(72) Inventor: Lorraine Campbell, County of Grande Prairie (CA)

(21) Appl. No.: 19/676,786

(22) Filed: May 13, 2026

(30) Foreign Application Priority Data
May 13, 2025 (CA) 3273742

(51) Int. Cl. B08B 1/16; A47J 37/07

(52) U.S. Cl. CPC B08B 1/165; A47J 37/0786

(57) ABSTRACT

A cooking grill cleaning tool has: a handle, with a plate connecting part at an end of the handle; and a grill cleaning plate that has: a peripheral edge that defines a plurality of edge zones distributed at different locations about the peripheral edge, with each edge zone defining a respective series of grill-receiving indents distributed along the edge zone; and a plurality of handle connecting parts distributed at different locations about the grill cleaning plate and each structured to be reversibly and selectively connected with and disconnected from the plate connecting part.

### TECHNICAL FIELD

This document relates to cooking grill cleaning tools with multiple configurations, and related methods of use.

### BACKGROUND

The following paragraphs are not an admission that anything discussed in them is prior art or part of the knowledge of persons skilled in the art.

Barbecue grill brush and scraper tools exist that include different sizes of cleaning indents, and multiple switchable heads.

### SUMMARY OF THE INVENTION

A cooking grill cleaning tool is disclosed comprising: a handle, with a plate connecting part at an end of the handle; and a grill cleaning plate that has: a peripheral edge that defines a plurality of edge zones distributed at different locations about the peripheral edge, with each edge zone defining a respective series of grill-receiving indents distributed along the edge zone; and a plurality of handle connecting parts distributed at different locations about the grill cleaning plate and each structured to be reversibly and selectively connected with and disconnected from the plate connecting part.

In various embodiments, there may be included any one or more of the following features: The grill cleaning plate defines opposed faces; and each edge zone is oriented at a different respective angular position about a plate axis normal to the opposed faces of the grill cleaning plate. The plurality of edge zones are oriented at one hundred twenty degree angles relative to one another about the plate axis. Each handle connecting part is oriented at a different respective angular position about the plate axis. The plurality of handle connecting parts are distributed at different locations about the peripheral edge between the plurality of edge zones. The plurality of edge zones comprises three or more edge zones. The plurality of handle connecting parts comprises three or more handle connecting parts. Each of the respective series of grill receiving-indents comprise indents of one or more of a different size and shape than the indents of the other series of grill receiving-indents. The grill receiving-indents comprise one or more of: a semi-circular edge profile; a three-sided box edge profile; a two-sided converging edge profile; or a curved edge profile. Each of the plurality of edge zones defines a straight edge. The plurality of handle connecting parts and the plate connecting part are structured to connect to one another via a threaded connection. The grill cleaning plate has a main body that defines opposed faces; and the grill cleaning plate has a plurality of flap parts on a periphery of the main body, with each flap part defining a respective edge zone of the plurality of edge zones. The plurality of flap parts are angled relative to a plane defined by one or both of the opposed faces. The plurality of flap parts are angled at forty-five degrees relative to the plane. The grill cleaning plate is formed of a sheet of metal. A method comprising using the cooking grill cleaning tool to clean a cooking grill. The method further comprising: disconnecting the plate connecting part from a first one of the plurality of handle connecting parts; and connecting the plate connecting part with a second one of the plurality of handle connecting parts.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a top plan view of a cooking grill cleaning tool with a cleaning head (grill cleaning plate) and a handle, with multiple handle attachment points on the cleaning head tool and differently sized grill indents on the cleaning head.

FIG. 2 is a bottom plan view of the cooking grill cleaning tool of FIG. 1.

FIG. 3 is a side elevation view of the cooking grill cleaning tool of FIG. 1.

FIG. 4 is an exploded view of the cooking grill cleaning tool of FIG. 1.

FIG. 5 is an exploded view of another embodiment of a cooking grill cleaning tool, with a series of threaded male handle attachment mechanism on the cleaning head.

FIG. 5A is a close up side elevation view of an edge of the plate incorporating various indents of different size and shape.

FIG. 6 is a top plan view of another embodiment of a grill cleaning plate for a cooking grill cleaning tool, the plate having a plate body and edge flap part parts that each mount a respective series of grill cleaning indents-in the example shown, the plate is in a flat state having been cut out of a blank of sheet metal without bending any of the flap part parts.

FIG. 7 is a side elevation view of the grill cleaning plate of FIG. 6.

FIG. 8 is a perspective view of the grill cleaning plate of FIG. 6, after the flap part parts have been bent, illustrating how the edge flap part parts are raised at a non-zero angle relative to a plane of the plate body.

FIGS. 9 and 10 are different side elevation views of the grill cleaning plate of FIG. 8.

FIG. 11 is a side elevation view of a cooking grill cleaning tool that incorporates the grill cleaning plate of FIG. 8, with multiple handle connection points or parts, one of which is connected to a handle.

FIG. 12 is a perspective view of the cooking grill cleaning tool of FIG. 11.

FIG. 13 is a top plan view of the cooking grill cleaning tool of FIG. 11 and bars of a cooking grill with debris on the bars.

### DETAILED DESCRIPTION

Immaterial modifications may be made to the embodiments described here without departing from what is covered by the claims.

A barbecue is a specialized cooking apparatus designed for outdoor cooking activities. A barbecue may use a suitable heat source, such as a charcoal, gas, or wood combustion device, or an electrical heater or element in some cases. A charcoal barbecue is used to impart a distinctive smoky flavor to food, using lump charcoal or briquettes that provide high, direct heat suitable for searing. A gas barbecue, fueled by propane or natural gas, offers convenience through rapid ignition and precise temperature control, making it ideal for versatile cooking. An electric barbecue, often used in environments where open flames are restricted, employs electric heating elements to provide consistent and controllable heat. A wood-fired barbecue may use hardwood logs or pellets, and may be preferred for the ability to infuse a rich, smoky essence into the food, often favored in traditional and artisanal barbecue practices. Modern barbecues may include advanced features such as infrared burners, which deliver intense, concentrated heat for even cooking, and smart technology for remote monitoring and control of cooking temperatures. Barbecues are designed with various configurations, including built-in, freestanding, and portable models, catering to different space requirements and user needs. The evolution of barbecues integrates both traditional methods and cutting-edge technology, enhancing the outdoor cooking experience for enthusiasts and professionals alike.

The grill of a barbecue or other cooking device is a critical component that directly affects the cooking process and the quality of the food produced. Typically constructed from materials such as stainless-steel, cast iron, or porcelain-coated steel, a grill or grate may incorporate a series of parallel bars on which food is exposed to heat. A grill may incorporate a frame of metal bars for holding food above a heat source. Thus, a grill in use must withstand high temperatures and resist corrosion. A stainless-steel grill may offer durability and ease of cleaning. A cast iron grill may provide excellent heat retention and relatively superior searing capabilities. A porcelain-coated grill may combine the benefits of cast iron or steel grills with a non-stick surface, which may reduce maintenance requirements. The design of the grill, including the spacing and size or thickness of the bars, influences heat distribution and the formation of grill marks, which are essential for both aesthetic and flavor purposes. Advanced grills may feature adjustable grills, allowing users to modify the distance between the food and the heat source for optimal cooking control. Additionally, some grill systems incorporate specialized zones or multi-tiered grill systems to enable simultaneous cooking of different types of food at varying temperatures. The choice of grill material and design directly impacts the grilling performance, making it a crucial factor for achieving desired culinary outcomes. The grill of a barbecue or other cooking device will commonly become dirty during use, requiring specialized tools to adequately and sanitarily dislodge and clear the surface of any debris and grease thereon.

Cleaning tools for barbecue grills are key for maintaining the hygiene and longevity of the grill, ensuring optimal performance and food safety. Basic cleaning tools may include grill brushes and scrapers. Grill brushes typically feature stainless steel or brass bristles for effective removal of food residues and carbon buildup, with variations such as wire brushes, coil brushes, and bristle-free models offering different cleaning intensities. Scrapers, often made of metal or hard plastic, are used to remove stubborn debris and grease from grill grills and surfaces, however, such may melt under high heat, and may otherwise quickly become saturated with debris and grease, requiring frequent cleaning of the tool itself. Some advanced scrapers come with replaceable blades and ergonomic handles for enhanced usability. Regular use of any kind of cleaning tool may extend the life of the grill and also ensure that food retains its intended flavors without contamination from old residues.

Existing grill cleaning tools have problems which can significantly impact their effectiveness and the overall maintenance of barbecue grills. One common problem is the shedding of bristles from wire grill brushes, which can pose a serious health hazard if ingested with food. As above, grill brushes may themselves require frequent cleaning, which may be difficult to execute in an adequate fashion. Bristle-free tools, while safer, may not always provide the same level of cleaning efficiency. Scrapers, particularly those made from softer materials, can wear down quickly or fail to remove tough, baked-on residues, necessitating frequent replacement. Additionally, metal scrapers can potentially damage the grill's surface or protective coatings, leading to rust and degradation over time, particularly where the grill incorporates a core of steel, which is prone to rusting when exposed to elements. Moreover, when a scraper is improperly sized for the grill, it can fail to clean effectively, missing debris in hard-to-reach areas or between bars, leading to uneven heating and potential food contamination. In addition, a single size of grill scraper may not be able to adequately clean certain grills, due to variations in grill spacings and thickness of bars, making it challenging to achieve consistent results across different grill models.

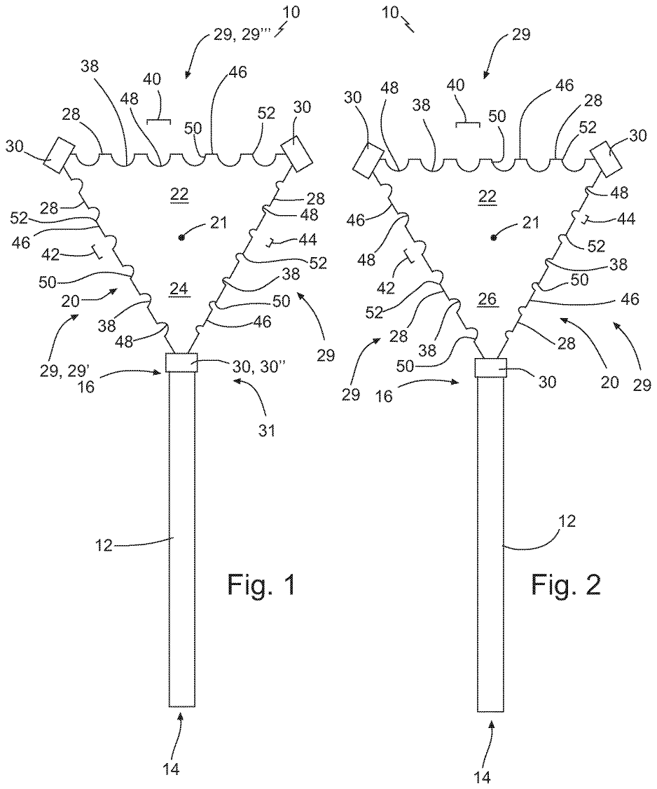

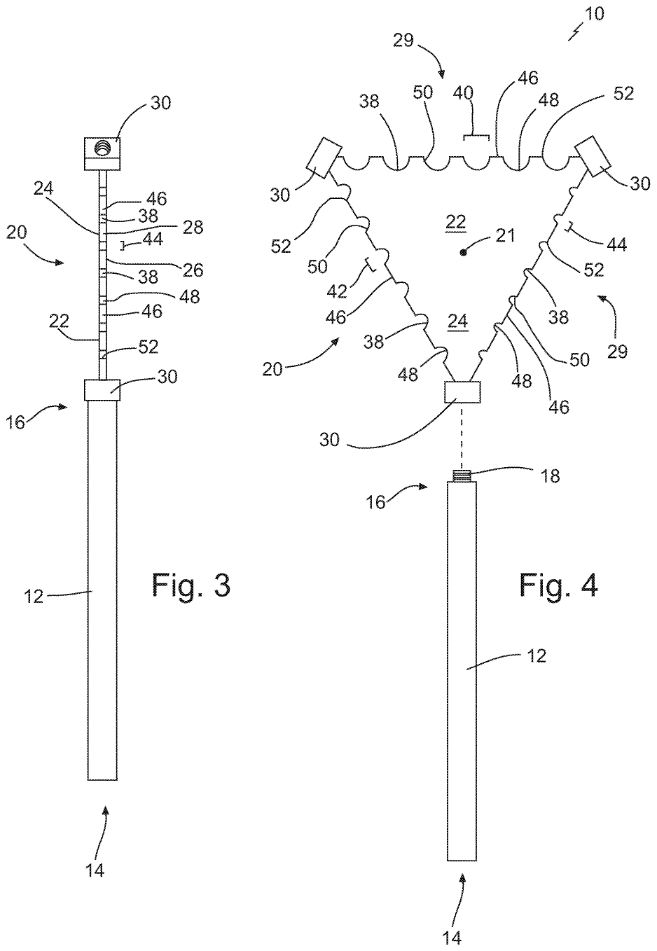

Referring to FIGS. 1-4, a cooking grill cleaning tool 10 is disclosed. The grill cleaning tool 10 comprises a handle 12 and a grill cleaning plate 20. The handle 12 may comprise a plate connecting part 18 at one end of the handle 12, for example the grill end 16 of the handle 12. The grill cleaning plate 20 may define a peripheral edge 28. The peripheral edge 28 may define a plurality of edge zones 29 distributed at different locations about the peripheral edge 28. Each edge zone 29 may define a respective series of grill-receiving indents 38 along the edge zone 29. Each series of grill-receiving indents 38 may comprise indents of different sizes, for example if a first series has 5 mm diameter indents, a second series has 7 mm indents, and a third series has 9 mm indents. The grill cleaning plate 20 may comprise a plurality of handle connecting parts 30 distributed at different locations about the grill cleaning plate 20. Each handle connecting part 30 may be structured to be reversibly and selectively connected to and disconnected from the plate connecting part 18. The reversible interconnection and disconnection may be independent, that is, the user may independently connect and disconnect the part 18 from any one of the parts 30 as desired. The handle connecting parts 30 may be structed to connect with the plate connecting part 18 via a suitable connection, such as via a threaded connection 31. The cooking grill cleaning tool 10 may be used by an operator to clean a cooking grill or grill 56, for example by scraping the plate 20 up and down a bar or series of bars of a grill while the bar or bars are received within one or more of the indents of a series of the respective indents on one of the edge zones. In use, one of the series of grill-receiving indents 38 may be placed onto the bars 60 of the cooking grill or grill 56 and the user may grip the user end 14 of the handle 12 and move the grill cleaning plate 20 back and forth to clean the cooking grill or grill. A user may select the appropriately size of series of indents 38 for the grill in question by disconnecting the plate connecting part 18 from a first one of the plurality of handle connecting parts 30 and connecting the plate connecting part 18 with a second one of the plurality of handle connecting parts 30.

Referring to FIGS. 1-4, the plurality of edge zones 29 may be each located at a suitable location on the grill cleaning plate 20. The grill cleaning plate 20 may define opposed faces, for example the top face 24 and the base face 26, which may be parallel with one another in the case of a sheet of metal. Each edge zone 29 may be oriented at a different respective angular position about a plate axis 21 normal to the opposed faces, for example the top face 24 and the base face 26, of the grill cleaning plate 20. The plurality of edge zones 29 may be oriented at a suitable orientations relative to one another, for example oriented at one hundred twenty degree angles relative to one another about the axis 21. There may be a suitable number of edge zones 29, for example the plurality of edge zones 29 may comprise three or more edge zones 29. The plurality of edge zones 29 may be oriented at different angles to one another depending on how many edge zones 29 are on the grill cleaning plate 20, the example, a plate 20 with four edge zones 29 may have the edge zones oriented at ninety degree angles relative to one another about the axis 21 normal to the opposed faces, for example top face 24 and base face 26, of the grill cleaning plate 20.

Referring to FIGS. 1-4, the handle 12 may be connectable to the plate 20 via the corresponding handle connecting parts 30. Each handle connecting part 30 may be oriented at a different respective angular position about the plate axis 21. The plate 20 may one or more handle connecting parts 30. There may be a suitable number of handle connecting parts 30. In the examples shown the plate 20 comprises three handle connecting parts 30, but the plate 20 may comprise more than three handle connecting parts 30. The plurality of handle connecting parts 30 may be located at suitable locations on the plate 20, for example distributed about or along the peripheral edge 28, for further example between the plurality of edge zones 29. The number of handle connecting parts 30 on the plate 20 may be the same as the number of edges zones 29 on the plate 20. Each handle connecting parts 30 may permit different uses for each of the plurality of edge zones 29, for example, when the handle 12 is connected to a first handle connecting part 30 the user may use a third edge zone 29′″ for a more traditional mode of cleaning a grill, by moving the tool 10 along a plane parallel and intersecting the axis 21. However, the user may find that the aforementioned maneuver is ideal for cleaning the top surface of the grill, but less ideal for cleaning the sides of the grill. Thus, the user may use one of the edge zones 29′ and 29″ adjacent the handle 12 for cleaning, permitting better access to the sides of the grill bars. If neither of the edge zones 29′ or 29″ are properly sized for the grill bars in question, then the user may re-orient the plate 20 relative to the handle 12 to put the edge zone 29′″ adjacent the handle 12.

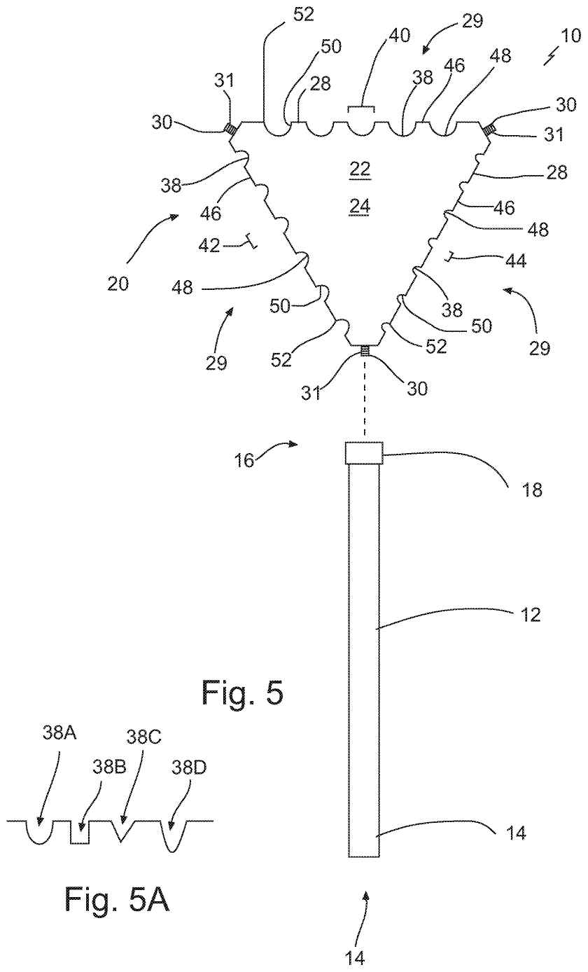

Referring to FIGS. 1-4, the grill receiving-indents 38 may have a variety of shapes and sizes. Each of the respective series of grill receiving-indents 38 may comprise indents 38 of one or more of a different size and shape than the indents 38 of the other series of grill receiving-indents 38. The indents 38 may differ in shape by varying an edge profile of the indent, whose edges may incorporate a base 48, inner side 50 or tip 52 of the indents 38. The indents 38 may differ in size by varying the radius of the indent 38 in the case of a curved indent profile, for example the series'of indents 38 may incorporate one of a large radius 40, an intermediate radius 42, or a small radius 44, for use on large, intermediate, or small grill bars respectively. Teeth 46 may be defined between the indents 38 on the peripheral edge 28 of the plate 20 of each zone. The spacing and size of the indents 38 may determine the size of the teeth 46. Different grates and grills may have varying sizes and shapes of bars and separation distances between bars. Therefore, varying the size, shape and spacing of the indents 38 may allow the different edge zones 29 to be suited for different respective grills, increasing the universality and scope of use of the tool 10. Referring to FIG. 5A, the grill receiving-indents 38 may comprise one or more of a semi-circular edge profile (indent 38A), a three-sided box edge profile (indent 38B) a two-sided converging edge profile (indent 38C) or a curved edge profile (indents 38A or 38D). Referring to FIGS. 1-4, each of the plurality of edge zones 29 may define a straight edge, for example peripheral edge 28, and the indents 38 and teeth 46 may be defined within the straight edge. Although the examples shown incorporate three series of indents, with the indents of each series identically-sized with the indents of the same series, other embodiments may incorporate a series of indents on an edge zone that have differently sized or shaped indents.

Referring to FIGS. 1-4, the handle 12 may be connected to the plate 20 via a suitable type of connection. The plurality of handle connecting parts 30 and the plate connecting part 18 may be structured to form a threaded connection 31. Threaded connections are a common mechanical fastening method used to join two or more components securely. Threaded connections use helical ridges, known as threads, which are either internal (female) or external (male), allowing them to be screwed together with precise torque control. Threaded connections ensure reliable joint integrity and can be disassembled and reassembled multiple times without significant loss of performance. The handle connecting parts 30 may comprise the male or female component of the threaded connection. The plate connecting part 18 may comprise the male or female component of the threaded connection 31. In the example shown in FIGS. 1-4, the handle connecting parts 30 may form female connecting parts, and the plate connecting part 18 may incorporate a male connecting part. In the example shown in FIG. 5, the handle connecting parts 30 may form male connecting parts, and the plate connecting part 18 may incorporate a female connecting part. The handle 12 may be connected to the plate 20 via other suitable connections, for example, snap-fit connections, bayonet mounts, quick-release fasteners, press fit connections, and magnetic fasteners.

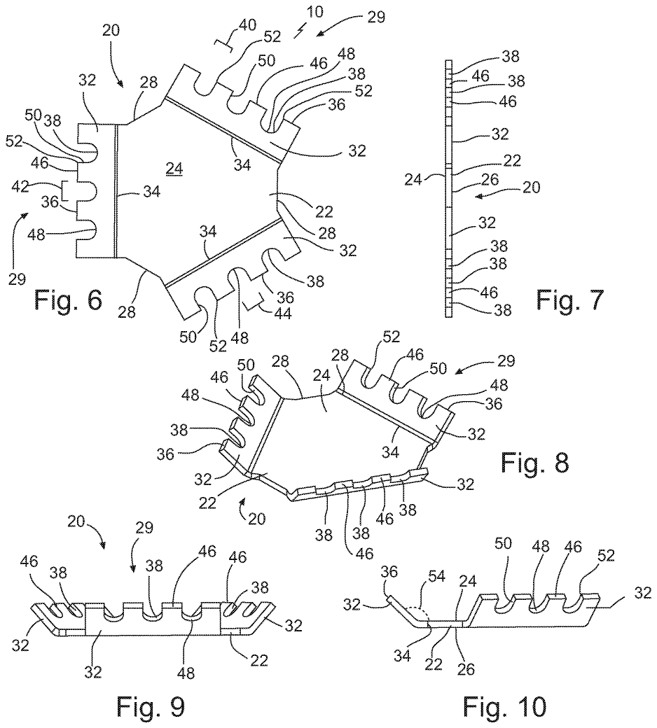

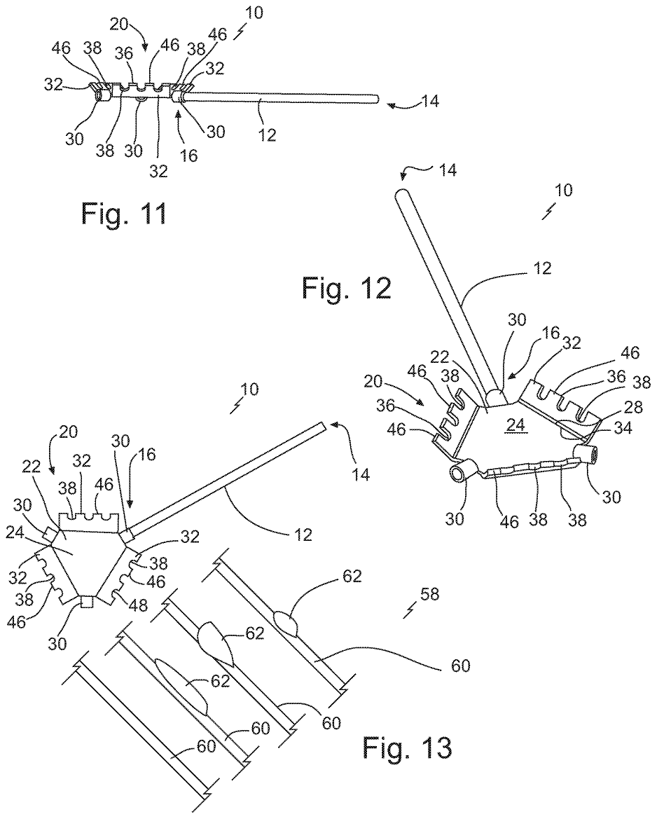

Referring to FIGS. 6-13, another embodiment of a cooking grill cleaning tool 10 is disclosed. The grill cleaning plate 20 of the tool 10 may comprise a main body 22 that defines opposed faces, such as top face 24 and bottom face 26. The grill cleaning plate 20 may comprise a plurality of flap parts 32, on a periphery of the main body 22, each flap part of which may define a respective edge zone 29 of the plurality of edge zones 29. The plurality of flap parts 32 may be angled relative to a plane defined by one or both of the opposed faces, such as the top face 24 and the bottom face 26. The plurality of flap parts 32 may be angled at a suitable angle 54 relative to a plane defined by one or both faces 24 and 26, for example the plurality of flap parts 32 may be angled at forty-five degrees relative to the plane. The flap parts 32 may define a base edge 34, which may be refer to the connection (which may be integral in the case of a sheet metal embodiment) to the main body 22. The indents 38 may be defined in a leading edge 36 of the flap parts 32. The main body 22 may mount the handle connection parts 30.

Referring to FIGS. 6-13, the grill cleaning plate 20 may be formed of a sheet of metal. The plate 20 may be formed using a punch and die, or other machining or cutting method (including laser cutting), to form the plate 12 in a flat configuration from a blank of sheet metal. The punch, driven by a press, exerts force on the sheet metal, pushing it through the die to create precise cutouts. Punching out may allow for high-speed production of complex geometries with tight tolerances. The plate 20 may be formed through a machining process, for example, using cutting tools to remove material from the surface to achieve the desired finish, precise dimensions, or specific features. This process may include milling, drilling, or grinding operations, depending on the required specifications. Machining is often employed to create flat surfaces, slots, or holes with tight tolerances that cannot be achieved through punching or bending alone. Referring to FIGS. 6-13, once the plate 20 is cut, the flap parts 32 of the plate 20 may be oriented into the final configuration shown in FIGS. 8-13 via bending. Bending sheet metal is typically performed using press brakes, which apply force through a punch and die set to create precise bends. Bending adds structural strength to the punched parts and allows for the creation of complex assemblies from flat sheet metal. Other bending techniques may be used.

Referring to FIG. 13, the plate 20 may be used in the embodiments shown in a handle mode, where the user connects the plate 20 to the handle 12 and operates the handle 12 to clean the grill 58. In some cases, the plate 20 may be used in a hand-held mode, where the plate 20 is disconnected from the handle 12 and operated directly to clean the grill without using the handle 12. The tool 10 may be operated to remove debris 62 from bars 60 of a grill 58.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A cooking grill cleaning tool comprising:
a handle, with a plate connecting part at an end of the handle; and
a grill cleaning plate that has:
a peripheral edge that defines a plurality of edge zones distributed at different locations about the peripheral edge, with each edge zone defining a respective series of grill-receiving indents distributed along the edge zone; and
a plurality of handle connecting parts distributed at different locations about the grill cleaning plate and each structured to be reversibly and selectively connected with and disconnected from the plate connecting part.

2. The cooking grill cleaning tool of claim 1 in which:
the grill cleaning plate defines opposed faces; and
each edge zone is oriented at a different respective angular position about a plate axis normal to the opposed faces of the grill cleaning plate.

3. The cooking grill cleaning tool of claim 2 in which the plurality of edge zones are oriented at one hundred twenty degree angles relative to one another about the plate axis.

4. The cooking grill cleaning tool of 2 in which each handle connecting part is oriented at a different respective angular position about the plate axis.

5. The cooking grill cleaning tool of claim 1 in which the plurality of handle connecting parts are distributed at different locations about the peripheral edge between the plurality of edge zones.

6. The cooking grill cleaning tool of claim 1 in which the plurality of edge zones comprises three or more edge zones.

7. The cooking grill cleaning tool of claim 1 in which the plurality of handle connecting parts comprises three or more handle connecting parts.

8. The cooking grill cleaning tool of claim 1 in which each of the respective series of grill receiving-indents comprise indents of one or more of a different size and shape than the indents of the other series of grill receiving-indents.

9. The cooking grill cleaning tool of claim 8 in which the grill receiving-indents comprise one or more of:
a semi-circular edge profile;
a three-sided box edge profile;
a two-sided converging edge profile; or
a curved edge profile.

10. The cooking grill cleaning tool of claim 1 in which each of the plurality of edge zones defines a straight edge.

11. The cooking grill cleaning tool of claim 1 in which the plurality of handle connecting parts and the plate connecting part are structured to connect to one another via a threaded connection.

12. The cooking grill cleaning tool of claim 1 in which:
the grill cleaning plate has a main body that defines opposed faces; and
the grill cleaning plate has a plurality of flap parts on a periphery of the main body, with each flap part defining a respective edge zone of the plurality of edge zones.

13. The cooking grill cleaning tool of claim 12 in which the plurality of flap parts are angled relative to a plane defined by one or both of the opposed faces.

14. The cooking grill cleaning tool of claim 13 in which the plurality of flap parts are angled at forty-five degrees relative to the plane.

15. The cooking grill cleaning tool of claim 1 in which the grill cleaning plate is formed of a sheet of metal.

16. A method comprising using the cooking grill cleaning tool of claim 1 to clean a cooking grill.

17. The method of claim 16 further comprising:
disconnecting the plate connecting part from a first one of the plurality of handle connecting parts; and
connecting the plate connecting part with a second one of the plurality of handle connecting parts.
